(19) United States
(12) Patent Application Publication
(10) Pub. No.: US 2020/0050002 A1
(43) Pub. Date: Feb. 13, 2020

(54) DISPLAY DEVICE AND DISPLAY CONTROL METHOD

(71) Applicant: HONDA MOTOR CO., LTD., Tokyo (JP)

(72) Inventors: Masafumi Higashiyama, Wako-shi (JP); Takuya Kimura, Wako-shi (JP); Shinji Kawakami, Wako-shi (JP); Tatsuya Iwasa, Wako-shi (JP); Yuji Kuwashima, Wako-shi (JP)

(21) Appl. No.: 16/508,469

(22) Filed: Jul. 11, 2019

(30) Foreign Application Priority Data
Aug. 7, 2018 (JP) 2018-148791

(51) Int. Cl. G02B 27/01; B60K 35/00

(52) U.S. Cl. CPC G02B 27/0179; B60K 35/00; B60R 2300/205; B60R 2300/308; B60K 2370/1529; B60R 2300/8093; G02B 2027/0181; G02B 2027/0183; B60K 2370/149; B60R 2300/8086

(57) ABSTRACT

A display device includes an image generation device which allows a viewer to visually recognize an image overlaid on a landscape, and a control device which controls the image generation device, wherein the control device infers a degree to which a viewer of the image has understood information represented by the image and controls the light projection device such that a visual attractiveness of the image is changed in response to the inferred degree of understanding.

### CROSS-REFERENCE TO RELATED APPLICATION

Priority is claimed on Japanese Patent Application No. 2018-148791, filed Aug. 7, 2018, the content of which is incorporated herein by reference.

### BACKGROUND

### Field of the Invention

The present invention relates to a display device, a display control method, and a storage medium.

### Description of Related Art

Conventionally, a head up display (HUD) device that displays an image related to basic information for a driver on a front windshield is known (refer to, for example, Japanese Unexamined Patent Application First Publication No. 2017-91115). Using this HUD device, the driver is able to ascertain various pieces of displayed information while maintaining a direction of a line of sight to the front at the time of driving by displaying various marks indicating an obstacle, a reminder, and a progress direction overlaid on a landscape in front of a vehicle.

### SUMMARY

However, in the conventional technique, a driver may feel the HUD display to be troublesome because even when the driver has already ascertained displayed content, HUD display of the same content may be continuously displayed.

An object of aspects of the present invention devised in view of the aforementioned circumstances is to provide a display device, a display control method, and a storage medium which can improve driver convenience.

A display device, a display control method, and a storage medium according to the present invention employ the following configurations.

(1): A display device according to one aspect of the present invention includes an image generation device which allows a viewer to visually recognize an image overlaid on a landscape, and a control device which controls the image generation device, wherein the control device infers a degree to which a viewer of the image has understood information represented by the image and controls the image generation device such that a visual attractiveness of the image is changed in response to the inferred degree of understanding.

(2): In the aforementioned aspect (1), the control device decreases the visual attractiveness when it is inferred that the degree of understanding has reached a predetermined degree of understanding.

(3): In the aforementioned aspect (2), the control device infers that the degree of understanding has reached a predetermined degree of understanding when the viewer has performed a predetermined response operation associated with the information represented by the image.

(4): In the aforementioned aspect (2), the control device infers that the degree of understanding has reached a predetermined degree of understanding when the viewer has visually recognized a projection position of the image for a predetermined checking time or longer.

(5): In the aforementioned aspect (2), when a next image to be displayed after the image has been understood is present, the control device causes the next image to be displayed in a state in which the visual attractiveness of the image has been decreased.

(6): In the aforementioned aspect (3), when the viewer has performed a predetermined response operation associated with the image before projection of the image, the control device infers that a predetermined degree of understanding has already been reached with respect to information represented by an image expected to be projected, and causes the image to be displayed in a state in which a visual attractiveness of the image has been decreased in advance.

(7): In the aforementioned aspect (1), the image generation device may include: a light projection device which outputs the image as light; an optical mechanism which is provided on a path of the light and is able to adjust a distance between a predetermined position and a position at which the light is formed as a virtual image; a concave mirror which reflects light that has passed through the optical mechanism toward a reflector; a first actuator which adjusts the distance in the optical mechanism; and a second actuator which adjusts a reflection angle of the concave mirror.

(8): A display device according to one aspect of the present invention includes an image generation device which allows a viewer to visually recognize an image overlaid on a landscape, and a control device which controls the image generation device, wherein the control device controls the light projection device such that a visual attractiveness of the image is changed when a viewer of the image has performed a predetermined response operation associated with information represented by the image.

(9): A display control method according to one aspect of the present invention includes, using a computer which controls an image generation device which allows a viewer to visually recognize an image overlaid on a landscape: inferring a degree to which a viewer of the image has understood information represented by the image; and controlling the image generation device such that a visual attractiveness of the image is changed in response to the inferred degree of understanding.

According to the aspects (1) to (10), it is possible to change display of information in response to a degree of understanding of a driver.

### BRIEF DESCRIPTION OF THE DRAWINGS

FIG. 1 is a diagram illustrating a configuration of an interior of a vehicle M on which a display device according to an embodiment is mounted.

FIG. 2 is a diagram for describing an operation switch of the embodiment.

FIG. 3 is a diagram showing a partial configuration of the display device.

FIG. 4 is a diagram showing an example of a configuration of the display device focusing on a display control device.

FIG. 5 is a diagram showing an example of a virtual image displayed by the display control device.

FIG. 6 is a diagram showing an example of an expected operation when an inference unit infers a degree of understanding of a driver.

FIG. 7 is a diagram showing another example of an expected operation when the inference unit infers a degree of understanding of a driver.

FIG. 8 is a diagram showing an example of visual attractiveness deterioration conditions of a virtual image displayed by the display control device.

FIG. 9 is a flowchart showing a flow of a process performed by the display device.

FIG. 10 is a diagram showing another example of display conditions of a virtual image displayed by the display control device.

### DETAILED DESCRIPTION OF THE INVENTION

Hereinafter, embodiments of a display device and a display control method of the present invention will be described with reference to the drawings. For example, the display device is a device that is mounted in a vehicle (hereinafter referred to as a vehicle M) and causes an image to be overlaid on a landscape and visually recognized. The display device can be referred to as an HUD device. As an example, the display device is a device that allows a viewer to visually recognize a virtual image by projecting light including an image to a front windshield of the vehicle M. Although the viewer may be a driver, for example, the viewer may be an occupant other than a driver. The display device may be realized by a display device having light transmissivity attached to the front windshield of the vehicle M (for example, a liquid crystal display or an organic electroluminescence (EL) display), and projects light on a transparent member (a visor, a lens of glasses, or the like) included in a device mounted on the body of a person. Alternatively, the display device may have a light transmissive display device attached thereto. In the following description, it is assumed that the display device is a device that is mounted in the vehicle M and projects light including an image to the front windshield.

In the following description, positional relationships and the like will be described using an XYZ coordinate system as appropriate.

[Overall Configuration]

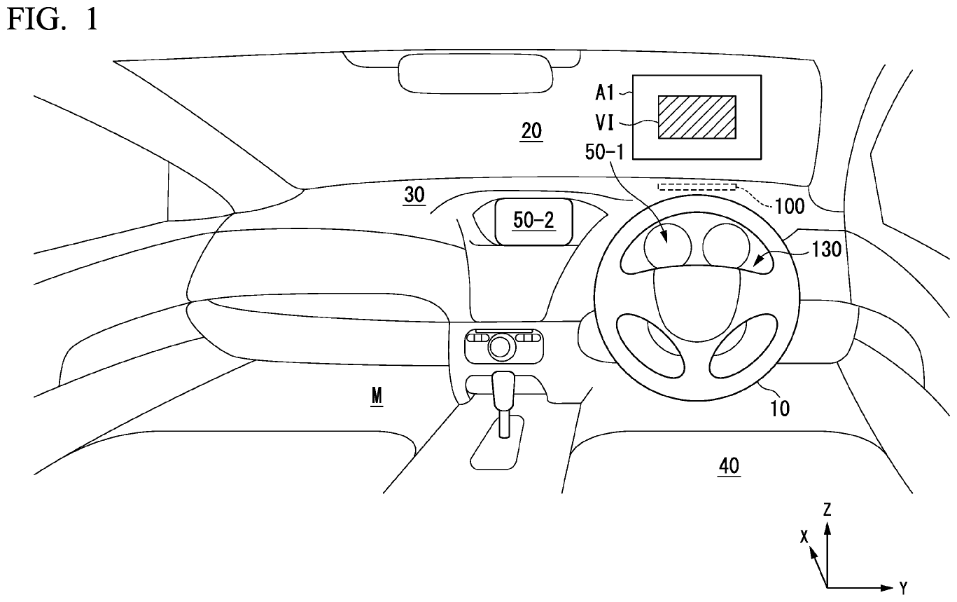

FIG. 1 is a diagram illustrating a configuration of an interior of the vehicle M on which a display device 100 according to an embodiment is mounted. The vehicle M is provided with, for example, a steering wheel 10 that controls steering of the vehicle M, a front windshield (an example of a reflector) 20 that separates the interior of the vehicle from the outside of the vehicle, and an instrument panel 30. The front windshield 20 is a member having light transmissivity. The display device 100 allows a driver sitting in a driver's seat 40 to visually recognize a virtual image VI by, for example, projecting (projecting) light including an image on a displayable area A1 included in a part of the front windshield 20 in front of the driver's seat 40.

The display device 100 causes the driver to visually recognize an imaged image including, for example, information for assisting the driver with driving as a virtual image VI. The information for assisting a driver with driving may include, for example, information such as the speed of the vehicle M, a driving force distribution ratio, an engine RPM, an operating state shift position of driving assistance functions, sign recognition results, and positions of intersections. The driving assistance functions include, for example, a direction indication function, adaptive cruise control (ACC), a lane keep assist system (LKAS), a collision mitigation brake system (CMBS), a traffic jam assist function, etc.

A first display device 50-1 and a second display device 50-2 may be provided in the vehicle M in addition to the display device 100. The first display device 50-1 is, for example, a display device that is provided on the instrument panel 30 near the front of the driver's seat 40 and is visually recognizable by a driver through a hole in the steering wheel 10 or over the steering wheel 10. The second display device 50-2 is attached, for example, to the center of the instrument panel 30. The second display device 50-2 displays, for example, images corresponding to navigation processing performed through a navigation device (not shown) mounted in the vehicle M, images of counterparts in a videophone, or the like. The second display device 50-2 may display television programs, play DVDs and display content such as downloaded movies.

The vehicle M is equipped with an operation switch (an example of an operator) 130 that receives an instruction for switching display of the display device 100 on/off and an instruction for adjusting the position of the virtual image VI. The operation switch 130 is attached, for example, at a position at which a driver sitting on the driver's seat 40 can operate the operation switch 130 without greatly changing their posture. The operation switch 130 may be provided, for example, in front of the first display device 50-1, on a boss of the steering wheel 10, or on a spoke that connects the steering wheel 10 and the instrument panel 30.

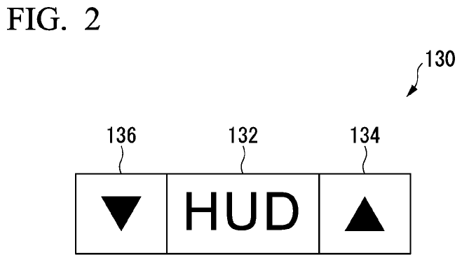

FIG. 2 is a diagram for describing the operation switch 130 of embodiments. The operation switch 130 includes a main switch 132 and adjustment switches 134 and 136, for example. The main switch 132 is a switch for switching the display device 100 on/off.

The adjustment switch 134 is, for example, a switch for receiving an instruction for moving the position of the virtual image VI visually recognized as being in a space having passed through the displayable area A1 from a line of sight position P1 of a driver upward in the vertical direction Z (hereinafter referred to as an upward direction). The driver can continuously move a position at which the virtual image VI is visually recognized within the displayable area A1 upward by continuously pressing the adjustment switch 134.

The adjustment switch 136 is a switch for receiving an instruction for moving the aforementioned position of the virtual image VI downward in the vertical direction Z (hereinafter referred to as a downward direction). The driver can continuously move a position at which the virtual image VI is visually recognized within the displayable area A1 downward by continuously pressing the adjustment switch 136.

The adjustment switch 134 may be a switch for increasing the luminance of the visually recognized virtual image VI instead of (or in addition to) moving the position of the virtual image VI upward. The adjustment switch 136 may be a switch for decreasing the luminance of the visually recognized virtual image VI instead of (or in addition to) moving the position of the virtual image VI downward. Details of instructions received through the adjustment switches 134 and 136 may be switched on the basis of some operations. Some operations may include, for example, an operation of long pressing the main switch 132. The operation switch 130 may include, for example, a switch for selecting displayed content and a switch for adjusting the luminance of an exclusively displayed virtual image in addition to each switch shown in FIG. 2.

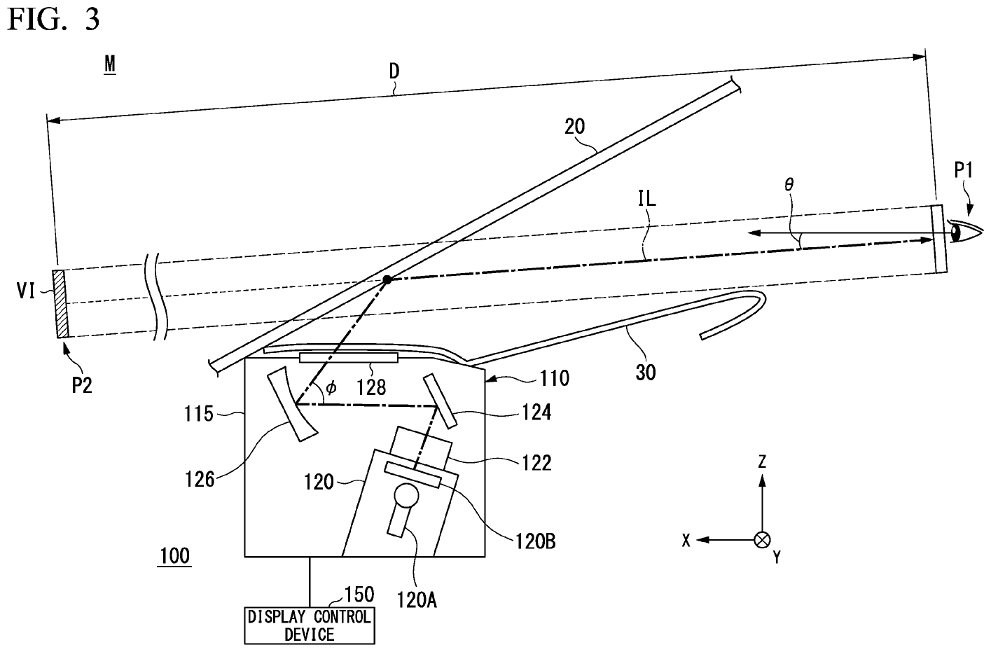

FIG. 3 is a diagram showing a partial configuration of the display device 100. The display device 100 includes a display 110 (an example of an image generation device) and a display control device (an example of a control device) 150. The display 110 accommodates a light projection device 120, an optical mechanism 122, a plane mirror 124, a concave mirror 126, and a light transmission cover 128, for example, in a housing 115. Although the display device 100 includes various sensors and actuators in addition to these components, they will be described later.

The light projection device 120 includes, for example, a light source 120A and a display element 120B. The light source 120A is a cold cathode tube, for example, and outputs visible light corresponding to the virtual image VI to be visually recognized by a driver. The display element 120B controls transmission of the visible light output from the light source 120A. For example, the display element 120B is a thin film transistor (TFT) type liquid crystal display (LCD). The display element 120B causes the virtual image VI to include image elements and determines a form (appearance) of the virtual image VI by controlling each of a plurality of pixels to control a degree of transmission of each color element of the visible light from the light source 120A. Visible light that is transmitted through the display element 120B and includes an image is referred to below as image light IL. The display element 120B may be an organic EL display. In this case, the light source 120A may be omitted.

The optical mechanism 122 includes one or more lenses, for example. The position of each lens can be adjusted, for example, in an optical-axis direction. The optical mechanism 122 is provided, for example, on a path of the image light IL output from the light projection device 120, passes the image light IL input from the light projection device 120 and projects the image light IL toward the front windshield 20.

The optical mechanism 122 can adjust a distance from the line of sight position P1 of the driver to a formation position P2 at which the image light IL is formed as a virtual image (hereinafter referred to as a virtual image visual recognition distance D), for example, by changing lens positions. The line of sight position P1 of the driver is a position at which the image light IL reflected by the concave mirror 126 and the front windshield 20 is condensed and is a position at which the eyes of the driver are assumed to be present. Although, strictly speaking, the virtual image visual recognition distance D is a distance of a line segment having a vertical inclination, the distance may refer to a distance in the horizontal direction when “the virtual image visual recognition distance D is 7 m” or the like is indicated in the following description.

In the following description, a depression angle θ is defined as an angle formed between a horizontal plane passing through the line of sight position P1 of the driver and a line segment from the line of sight position P1 of the driver to the formation position P2. The further downward the virtual image VI is formed, that is, the further downward the line of sight direction at which the driver views the virtual image VI is formed, the larger the depression angle θ is. The depression angle θ is determined on the basis of a reflection angle φ of the concave mirror 126 and a display position of an original image in the display element 120B described later. The reflection angle φ is an angle formed between an incident direction in which the image light IL reflected by the plane mirror 124 is input to the concave mirror 126 and a projection direction in which the concave mirror 126 projects the image light IL.

The plane mirror 124 reflects visible light (i.e., the image light IL) that has been emitted from the light source 120A and passed through the display element 120B in the direction of the concave mirror 126.

The concave mirror 126 reflects the image light IL input from the plane mirror 124 and projects the reflected image light IL to the front windshield 20. The concave mirror 126 is supported so as to be rotatable (pivotable) on the Y axis that is an axis in the width direction of the vehicle M.

The light transmission cover 128 transmits the image light IL from the concave mirror 126 to cause the image light IL to arrive at the front windshield 20 and prevent foreign matter such as dust, dirt or water droplets from infiltrating into the housing 115. The light transmission cover 128 is provided in an opening formed in an upper member of the housing 115. The instrument panel 30 also includes an opening or a light transmissive member, and the image light IL passes through the light transmission cover 128 and the opening or the light transmissive member of the instrument panel 30 to arrive at the front windshield 20.

The image light IL input to the front windshield 20 is reflected by the front windshield 20 and condensed at the line of sight position P1 of the driver. Here, the driver perceives an image projected by the image light IL as being displayed in front of the vehicle M.

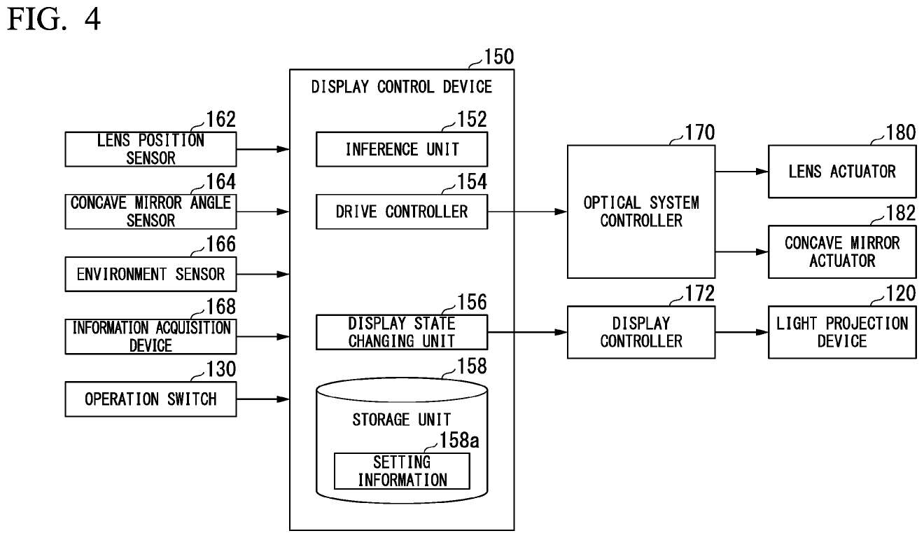

The display control device 150 controls display of the virtual image VI visually recognized by the driver. FIG. 4 is a diagram showing an example of a configuration of the display device 100 focusing on the display control device 150. The example of FIG. 4 shows a lens position sensor 162, a concave mirror angle sensor 164, an environment sensor 166, an information acquisition device 168, an operation switch 130, an optical system controller 170, a display controller 172, a lens actuator (an example of a first actuator) 180, a concave mirror actuator (an example of a second actuator) 182, and the light projection device 120 included in the display device 100 in addition to the display control device 150.

The lens position sensor 162 detects positions of one or more lenses included in the optical mechanism 122. The concave mirror angle sensor 164 detects a rotation angle of the concave mirror 126 on the Y axis shown in FIG. 3. The environment sensor 166 detects, for example, the temperatures of the light projection device 120 and the optical mechanism 122. The environment sensor 166 detects illumination around the vehicle M. The information acquisition device 168 is, for example, an electronic control unit (ECU) and the like (e.g., an engine ECU and a steering ECU) mounted in the vehicle M and acquires the speed and steering angle of the vehicle M on the basis of outputs of sensors which are not shown. The information acquisition device 168 may analyze images of a camera mounted in the information acquisition device 168 to detect actions and expressions of occupants including the driver.

The display control device 150 includes, for example, an inference unit 152, a drive controller 154, a display state changing unit 156, and a storage unit 158. Among these, components other than the storage unit 158 are realized, for example, by a hardware processor such as a central processing unit (CPU) executing a program (software). Some or all of these components may be realized by hardware (circuitry: including a circuit) such as a large scale integration (LSI) circuit, an application specific integrated circuit (ASIC), a field-programmable gate array (FPGA), or a graphics processing unit (GPU) or realized by software and hardware in cooperation. The program may be stored in a storage device such as the storage unit 158 in advance or stored in a detachable storage medium such as a DVD or a CD-ROM and installed in an HDD or a flash memory of the display control device 150 according to insertion of the storage medium into a drive device.

The inference unit 152 infers a degree to which the driver has understood displayed contents of the virtual image VI on the basis of an operation quantity of a driving operator such as the steering wheel 10 (e.g., the aforementioned steering angle) detected by the information acquisition device 168 and an action or expression of the driver detected by the information acquisition device 168. The inference unit 152 outputs the inferred degree of understanding to the display state changing unit 156.

The drive controller 154 adjusts the position of the virtual image VI to be visually recognized by the driver, for example, depending on operation contents from the operation switch 130. For example, the drive controller 154 outputs a first control signal for moving the position of the virtual image VI upward in the displayable area A1 to the optical system controller 170 when an operation of the adjustment switch 134 has been received. Moving the virtual image VI upward is decreasing a depression angle θ1 formed between a horizontal direction with respect to the line of sight position of the driver shown in FIG. 3 and a direction in which the virtual image VI is visually recognized at the light of sight position, for example. The drive controller 154 outputs a first control signal for moving the position of the virtual image VI downward in the displayable area A1 to the optical system controller 170 when an operation of the adjustment switch 136 has been received. Moving the virtual image VI downward is increasing the depression angle θ1, for example.

The drive controller 154 output a second control signal for adjusting the virtual image visual recognition distance D to the optical system controller 170, for example, on the basis of a speed of the vehicle M detected by the information acquisition device 168. The drive controller 154 controls the optical mechanism 122 such that the optical mechanism 122 changes the virtual image visual recognition distance D depending on the speed of the vehicle M. For example, the drive controller 154 increases the virtual image visual recognition distance D when the speed of the vehicle M is high and decreases the virtual image visual recognition distance D when the speed of the vehicle M is low. The drive controller 154 controls the optical mechanism 122 such that the optical mechanism 122 minimizes the virtual image visual recognition distance D while the vehicle M is stopped.

The display state changing unit 156 changes a display state of the virtual image VI in response to a degree of understanding output from the inference unit 152. Change of a display state according to the display state changing unit 156 will be described later.

The storage unit 158 is realized by, for example, an HDD, a random access memory (RAM), a flash memory or the like. The storage unit 158 stores setting information 158a referred to by the inference unit 152 and the display state changing unit 156. The setting information 158a is information in which relations between estimation results and display states have been regulated.

The optical system controller 170 drives the lens actuator 180 or the concave mirror actuator 182 on the basis of a first control signal or a second control signal received by the drive controller 154. The lens actuator 180 includes a motor and the like connected to the optical mechanism 122 and adjusts the virtual image visual recognition distance D by moving the positions of one or more lenses in the optical mechanism 122. The concave mirror actuator 182 includes a motor and the like connected to the rotation axis of the concave mirror 126 and adjusts the reflection angle of the concave mirror 126.

For example, the optical system controller 170 drives the lens actuator 180 on the basis of the first control signal information acquired from the drive controller 154 and drives the concave mirror actuator 182 on the basis of the second control signal information acquired from the drive controller 154.

The lens actuator 180 acquires a driving signal from the optical system controller 170 and moves the positions of one or more lenses included in the optical mechanism 122 by driving the motor and the like on the basis of the acquired driving signal. Accordingly, the virtual image visual recognition distance D is adjusted.

The concave mirror actuator 182 acquires a driving signal from the optical system controller 170 and adjusts the reflection angle φ of the concave mirror 126 by driving the motor and rotating the concave mirror actuator 182 on the Y axis on the basis of the acquired driving signal. Accordingly, the depression angle θ is adjusted.

The display controller 172 projects predetermined image light IL to the light projection device 120 on the basis of display control information from the display state changing unit 156.

[Method of Estimating Degree of Understanding]

Hereinafter, a method of estimating a degree to which the driver has understood the virtual image VI performed by the inference unit 152 will be described. The inference unit 152 infers a degree to which the driver has understood information represented by displayed contents of the virtual image VI, for example, on the basis of navigation processing performed by the navigation device and an operation quantity of a driving operator detected by the information acquisition device 168.

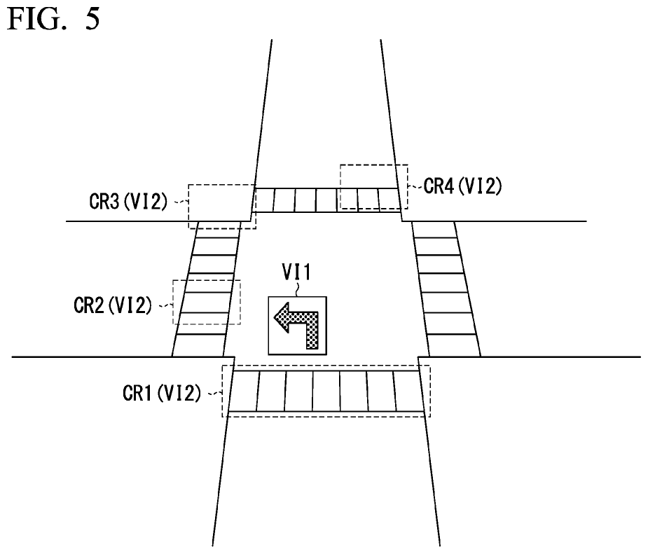

FIG. 5 is a diagram showing an example of the virtual image VI displayed by the display control device 150. When the information acquisition device 168 detects the vehicle M approaching to an intersection and intending to turn left at the intersection, the display control device 150 display a virtual image VI1 of turn-by-turn navigation which represents left turn at the intersection in the displayable area A1.

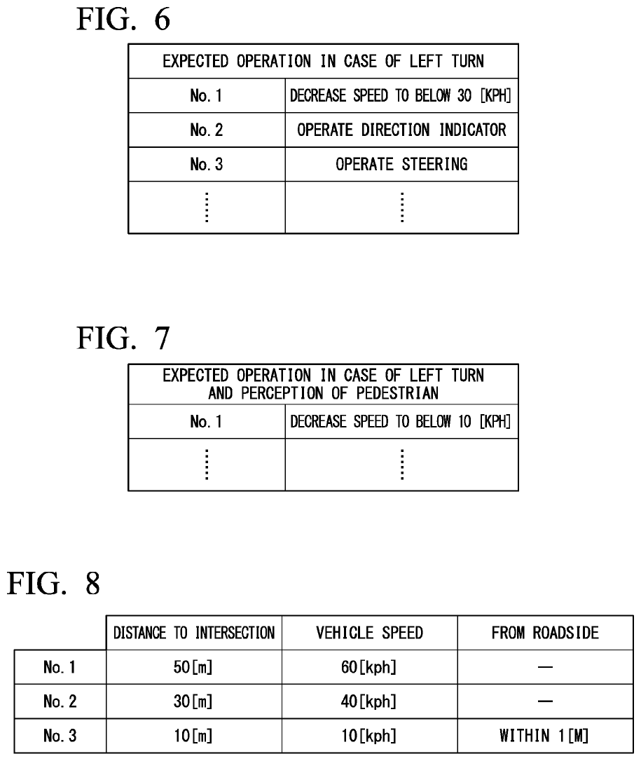

The inference unit 152 infers a degree of understanding of information represented by displayed contents of the virtual image VI1, for example, on the basis of an operation of the driver after the virtual image VI1 is displayed. HG 6 is a diagram showing an example of an expected operation when the inference unit 152 infers a degree of understanding of the driver, which are stored in the setting information 158a. In a situation in which the vehicle M is caused to turn left, the display control device 150 displays the virtual image VI1 shown in FIG. 5. When the driver performs a driving operation for realizing an expected operation associated with left turn as shown in FIG. 6 after the virtual image VI1 is displayed, the inference unit 152 infers that the driver has understood the virtual image VI1. The expected operation shown in FIG. 6 is an example of “a predetermined response operation.”

Setting in which performing an operation of decreasing the vehicle speed to below 30 [kph] No. 1 of FIG. 6) by the driver, operating a turn signal to indicate left turn (No. 2 of FIG. 6) and operating an operator such as the steering wheel 10 such that the vehicle turns left (No. 3 of FIG. 6) are set as an expected operation is stored in the inference unit 152 in a traveling situation in which the vehicle M turns left. When the vehicle M intends to turn left, if the information acquisition device 168 detects execution of an expected operation by the driver or start of the expected operation, the inference unit 152 determines that a predetermined degree of understanding has been reached. When an expected operation is composed of a plurality of operations, the operation order (e.g., the order of No. 1 to No. 3 of FIG. 6) may be set.

When an expected operation is composed of a plurality of operations, an essential expected operation and an arbitrary (non-essential) expected operation may be set. In four areas CR1 to CR4 of virtual images VI2 shown in FIG. 5, for example, since it is desirable that the areas CR1 and CR2 including crosswalks through which the vehicle M passes when turning left at the intersection be necessarily checked with the eyes by the driver, checking the areas CR1 and CR2 with the eyes is set as an essential expected operation. Similarly, checking the area CR3 with the eyes is set as an essential expected operation in order to check presence or absence of traffic participants such as pedestrians who pass through the crosswalks through which the vehicle M passes when turning left at the intersection at the same timing with the vehicle M. On the other hand, presence or absence of traffic participants in the area CR4 is less likely to affect control of driving of the vehicle M and thus checking the area CR4 may be set as an arbitrary expected operation.

The display state changing unit 156 continuously displays the virtual images VI2 until an essential expected operation is performed, and when the information acquisition device 168 detects that the essential operation has been performed, decreases visual attractiveness of the virtual images VI2. In the example of FIG. 5, the display state changing unit 156 decreases a visual attractiveness of the virtual images VI2 when the virtual images VI2 are continuously displayed and turning left of the vehicle M ends without detecting execution of an essential operation through the information acquisition device 168.

FIG. 7 is a diagram showing another example of an expected operation when the inference unit 152 infers a degree of understanding of the driver, which is stored in the setting information 158a. In a traveling situation in which the vehicle M turns left at an intersection, and a pedestrian has been detected near the intersection, the inference unit 152 infers that the driver has perceived the pedestrian if the vehicle speed decreases to below a predetermined vehicle speed of 10 [kph] when overlapping a motion vector of the pedestrian detected by the information acquisition device 168 and a motion vector of the vehicle M is predicted.

### Modified Example

Step-by-step conditions may be set for each distance between the vehicle M and the intersection in the expected operations shown in FIG. 6 and FIG. 7 in a traveling situation in which the vehicle M turns left at the intersection. FIG. 8 is a diagram showing an example of conditions for deletion of the virtual image VI1 caused to be displayed by the display control device 150, which are stored in the setting information 158a. When the vehicle M intends to turn left at an intersection, and a visual attractiveness deterioration condition associated with a case of left turn at an intersection shown in FIG. 8 is satisfied, the display control device 150 deletes the virtual image VI1 from the displayable area A1. The display control device 150 decreases a visual attractiveness of the virtual image VI, for example, all conditions of No. 1 to No. 3 shown in FIG. 8 are satisfied. Visibility is decreased when the step-by-step conditions of No. 1 to No. 3 shown in FIG. 8 are satisfied, and visibility of the virtual image VI is improved when a condition in the next step is not satisfied.

When the information acquisition device 168 detects that the vehicle M is located within a distance of 10 [m] from an intersection, the speed of the vehicle M is equal to or higher than 10 [kph] and a distance to a roadside is equal to or greater than 10 [m], for example, the inference unit 152 infers that the driver is not ready to turn left or is not sufficiently ready to turn left. On the other hand, when the information acquisition device 168 detects that the vehicle M is located within a distance of 10 [m] from an intersection, the speed of the vehicle M is less than 10 [kph] and a distance to a roadside is less than 10 [m], the inference unit 152 infers that the driver has already understood turning left.

[Processing Flow]

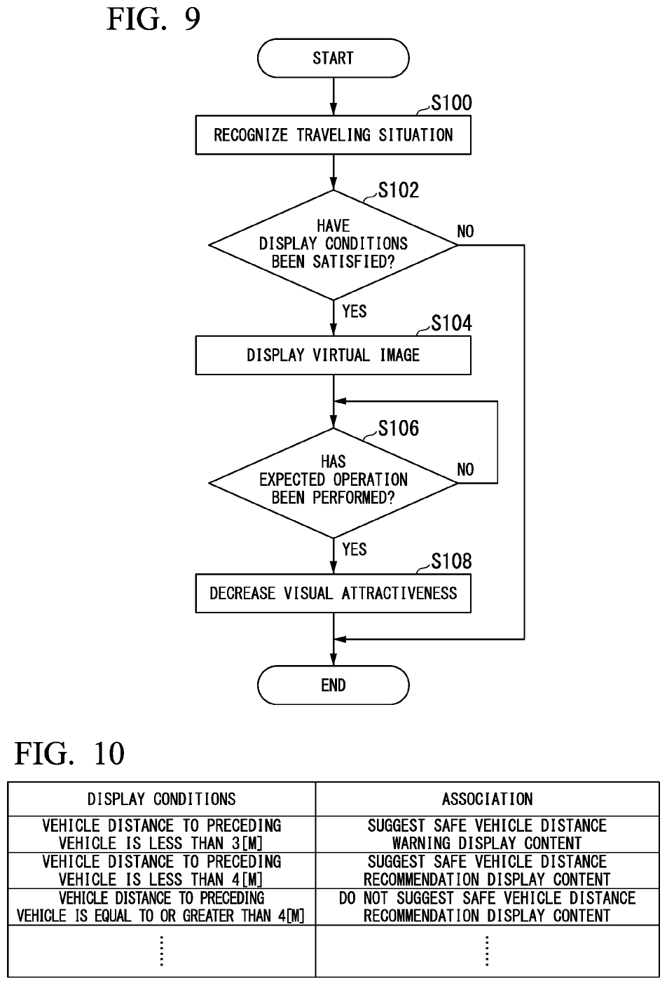

FIG. 9 is a flowchart showing a flow of a process performed by the display device 100 of embodiments. First, the information acquisition device 168 recognizes a traveling situation of the vehicle M (step S100). Next, the inference unit 152 determines whether display conditions have been satisfied (step S102). When it is determined that the display conditions have been satisfied, the inference unit 152 causes the display control device 150 to display a virtual image VI1 (step S104). The inference unit 152 ends the process of the flowchart when it is determined that the display conditions have not been satisfied.

After the process of step S104, the inference unit 152 infers a degree to which the driver has understood the virtual image VI1 on the basis of whether an expected operation has been performed (step S106). When an expected operation has not been performed, the inference unit 152 performs the process of step S106 again after lapse of a specific time. When an expected operation has been performed, the inference unit 152 determines that a degree to which the driver has understood displayed contents of the virtual image VI1 has reached a predetermined degree of understanding and decreases a visual attractiveness of the virtual image VI1 (step S108). In this manner, description of the process of this flowchart ends.

[Change of Virtual Image]

The inference unit 152 changes a virtual image VI to be caused to be displayed by the display control device 150 according to an operation of the driver. Referring back to HG 5, when the inference unit 152 determines that the driver understands the virtual image VI1 and starts control of driving for turning left the vehicle M, the inference unit 152 decreases a visual attractiveness of the virtual image VI1 and simultaneously displays next information required to invite attention of the driver as a new virtual image VI2.

When the information acquisition device 168 detects that a direction indicator has been operated to indicate left turn, the inference unit 152 infers that the driver has understood the virtual image VI1 of turn-by-turn navigation and decreases a visual attractiveness of the virtual image VIE Deterioration of visual attractiveness will be described later. Further, the inference unit 152 displays a virtual image VI2 for causing the driver to check that there is no traffic participant such as a pedestrian or a bicycle on a crosswalk at an intersection. When the displayable area A1 can be overlaid on the areas CR1 to CR4 of an actual landscape, the display device 100 may display the virtual image VI2 overlaid on the areas CR1 to CR4. When the displayable area A1 cannot be overlaid on the areas CR1 to CR4 of an actual landscape, the display device 100 displays the virtual image VI2 that suggests the areas CR1 to CR4.

[Deterioration of Visual Attractiveness of Virtual Image]

When it is inferred that the driver has already understood information included in the virtual image VI from an operation of the driver performed before a display timing of the virtual image VI, the inference unit 152 may display the virtual image VI in a state in which the visual attractiveness thereof has been decreased in advance. For example, when the information acquisition device 168 detects that the driver starts to decrease the speed of the vehicle M or to operate a direction indicator before approaching the traveling situation in which the vehicle turns left at an intersection as shown in FIG. 5, the inference unit 152 infers that the driver understands turning at the intersection and the virtual VI need not be displayed and stops display of the virtual image VI.

[Change of Visual Attractiveness]

The display state changing unit 156 changes visual attractiveness of the virtual image VI in response to a degree of understanding output from the inference unit 152. The display state changing unit 156 decreases a visual attractiveness of the virtual image VI when the inference unit 152 infers that a degree of understanding of the driver has reached a predetermined degree of understanding. Deteriorating visual attractiveness is deteriorating the luminance of the virtual image VI to below a standard intensity, gradually deleting display of the virtual image VI, decreasing a display size of the virtual image VI, or moving the position at which the virtual image VI is displayed to an edge of the displayable area A1, for example.

The display state changing unit 156 improves visual attractiveness of the virtual image VI when the inference unit 152 infers that a degree of understanding of the driver has not reached the predetermined degree of understanding even after lapse of a specific time from start of display of the virtual image VI. Improving visual attractiveness is increasing a display size of the virtual image VI, flashing the virtual image VI, or increasing the luminance of the virtual image VI, for example.

[Support of Driving Manner and Driving Technique Improvement]

The display control device 150 may suggest the reason why deterioration of visibility of the virtual image VI is not performed as expected, such as a case in which an expected operation is not performed by the driver, a case in which driving manner of the driver detected by the information acquisition device 168 does not satisfy a predetermined regulation, or a case improvement of a driving technique is desirable, to the driver to call for improvement.

FIG. 10 is a diagram showing an example of display conditions including driving manners which are stored in the setting information 158a. For example, when the information acquisition device 168 detects that the vehicle M is traveling and a distance between the vehicle M and a preceding vehicle has become equal to or less than an appropriate distance (e.g., about 4 [m]), the display control device 150 displays a virtual image VI for causing the driver to increase the distance between the vehicles. When the distance between the vehicles has become equal to or greater than a predetermined distance or the driver has performed an operation such as decreasing the vehicle speed after safe vehicle distance recommendation display content has been displayed as the virtual image VI to cause the driver to increase the distance between the vehicles, for example, the inference unit 152 infers that a predetermined degree of understanding has reached.

For example, when the information acquisition device 168 detects that a distance between the vehicle M and a preceding vehicle is equal to or less than an appropriate distance and detects that the distance has become equal to or less than a distance (e.g., about 3 [m]) that requires adjustment of the distance between the vehicles in an early stage, the display control device 150 displays a virtual image VI for warning the driver such that the driver increase the distance between the vehicles.

The display control device 150 may display the safe vehicle distance recommendation display content as a virtual image VI at a timing at which improvement is determined to be desirable or a timing the same as or similar to a traveling situation in which improvement is determined to be desirable.

The display control device 150 may suggest the reason why deterioration of visibility of the virtual image VI is not performed as expected to the driver through the display device 100 or other output devices (e.g., an output unit of a navigation device).

[Other Inference Methods]

The inference unit 152 may infer a degree of understanding of the driver on the basis of a motion of the head or a motion of the eyes of the driver detected by the information acquisition device 168. When the information acquisition device 168 detects that a line of sight of the driver conjectured from a line of sight position of the driver and the displayable area A1 in which the virtual image VI is displayed overlap for a predetermined checking time (e.g., 0.2 [seconds]) or longer, for example, the inference unit 152 infers that the virtual image VI has been visually checked for at least the predetermined checking time and a predetermined degree of understanding has reached.

Although the inference unit 152 infers a degree of understanding on the basis of an operation of the driver in the above-described example, the inference unit 152 may infer that a predetermined degree of understanding has reached when the information acquisition device 168 detects a voice input of a phrase including a specific word (e.g., “left turn” or “understood” in the case of the situation shown in FIG. 5) for indicating that the driver has understood the virtual image VI. The inference unit 152 may infer that a predetermined degree of understanding has reached when the driver sets an arbitrary gesture (e.g., nodding multiple times or winking multiple times) indicating that the driver has understood the virtual image VI in advance and the information acquisition device 168 detects that gesture.

[Other HUD Display Areas]

The display device 100 may project an image on a light transmissive reflection member such as a combiner provided between the position of the driver and the front windshield 20 instead of directly projecting an image on the front windshield 20.

As described above, the display device 100 includes the display 110 which allows a viewer such as a driver to visually recognize an image overlaid on a landscape, and the display control device 150 which controls an image generation device, wherein the display control device 150 includes the inference unit 152 which infers a degree to which the occupant has understood information represented by the virtual image VI projected by the light projection device 120, and the display state changing unit 156 which controls the light projection device 120 such that a visual attractiveness of the virtual image VI is changed in response to the degree of understanding inferred by the inference unit 152. Accordingly, it is possible to improve driver convenience by changing display of information in response to a degree to which an occupant has understood a virtual image VI.

While forms for embodying the present invention have been described using embodiments, the present invention is not limited to these embodiments and various modifications and substitutions can be made without departing from the spirit or scope of the present invention.

What is claimed is:

1. A display device comprising:
an image generation device which allows a viewer to visually recognize an image overlaid on a landscape; and
a control device which controls the image generation device,
wherein the control device infers a degree to which a viewer of the image has understood information represented by the image and controls the image generation device such that a visual attractiveness of the image is changed in response to the inferred degree of understanding.

2. The display device according to claim 1, wherein the control device decreases a visual attractiveness when it is inferred that the degree of understanding has reached a predetermined degree of understanding.

3. The display device according to claim 2, wherein the control device infers that the degree of understanding has reached a predetermined degree of understanding when the viewer has performed a predetermined response operation associated with the information represented by the image.

4. The display device according to claim 2, wherein the control device infers that the degree of understanding has reached a predetermined degree of understanding when the viewer has visually recognized a projection position of the image for a predetermined checking time or longer.

5. The display device according to claim 2, wherein, when a next image to be displayed after the image has been understood is present, the control device causes the next image to be displayed in a state in which the visual attractiveness of the image has been decreased.

6. The display device according to claim 3, wherein, when the viewer has performed a predetermined response operation associated with the image before projection of the image, the control device infers that a predetermined degree of understanding has already been reached with respect to information represented by an image expected to be projected, and causes the image to be displayed in a state in which a visual attractiveness of the image has been decreased in advance.

7. The display device according to claim 1, wherein the image generation device includes:
a light projection device which outputs the image as light;
an optical mechanism which is provided on a path of the light and is able to adjust a distance between a predetermined position and a position at which the light is formed as a virtual image;
a concave mirror which reflects light that has passed through the optical mechanism toward a reflector;
a first actuator which adjusts the distance in the optical mechanism; and
a second actuator which adjusts a reflection angle of the concave mirror.

8. A display device comprising:
an image generation device which allows a viewer to visually recognize an image overlaid on a landscape; and
a control device which controls the image generation device,
wherein the control device controls the image generation device such that a visual attractiveness of the image is changed when a viewer of the image has performed a predetermined response operation associated with information represented by the image.

9. A display control method comprising, using a computer which controls an image generation device which allows a viewer to visually recognize an image overlaid on a landscape:
inferring a degree to which a viewer of the image has understood information represented by the image; and
controlling the image generation device to change visual attractiveness of the image in response to the inferred degree of understanding.
